(19) United States
(12) Patent Application Publication
(10) Pub. No.: US 2018/0167431 A1
(43) Pub. Date: Jun. 14, 2018

(54) CLIENT-SIDE ACK REGULATION BASED ADAPTIVE STREAMING METHOD AND APPARATUS

(71) Applicants: SNU R&DB FOUNDATION, Seoul (KR); INDUSTRIAL COOPERATION FOUNDATION CHONBUK NATIONAL UNIVERSITY, Jeollabuk-do (KR)

(72) Inventors: Seo Hyang KIM, Seoul (KR); Chong Kwon KIM, Seoul (KR); Gi Hwan CHO, Jeollabuk-do (KR)

(73) Assignees: SNU R&DB FOUNDATION, Seoul (KR); INDUSTRIAL COOPERATION FOUNDATION CHONBUK NATIONAL UNIVERSITY, Jeollabuk-do (KR)

(21) Appl. No.: 15/385,015

(22) Filed: Dec. 20, 2016

(30) Foreign Application Priority Data
Dec. 8, 2016 (KR) 10-2016-0167001

(51) Int. Cl. H04L 29/06; H04L 12/841; H04L 12/24

(52) U.S. Cl. CPC H04L 65/4092; H04L 65/80; H04L 41/0896; H04L 47/283; H04L 65/604

(57) ABSTRACT

Provided is a client-side ACK regulation based adaptive streaming method including changing a goal download time (GDT) of a video segment and regulating an app buffer level, regulating reading of a receive socket on the basis of a leaky bucket and determining the number of tokens using the changed GDT, and controlling a size of a receive socket buffer on the basis of the determined number of tokens.

### CROSS-REFERENCE TO RELATED APPLICATION

This application claims priority to and the benefit of Korean Patent Application No. 10-2016-0167001, filed on Dec. 8, 2016, the disclosure of which is incorporated herein by reference in its entirety.

### BACKGROUND

### 1. Field of the Invention

The present invention relates to a data streaming method and system, and more particularly, to a client-side ACK regulation based adaptive streaming method and system that control size of a transmission control protocol (TCP) socket buffer and control reading of data in the TCP socket buffer so that streaming quality is increased to prevent deterioration of streaming quality that occurs when multiple streaming users share one bottleneck link.

The present invention was supported by both the MSIP(Ministry of Science, ICT and Future Planning), Korea, under the ITRC(Information Technology Research Center) support program (IITP-2016-R0992-16-1023) supervised by the IITP(Institute for Information & communications Technology Promotion) and Institute for Information & communications Technology Promotion(IITP) grant funded by the Korea government(MSIP) (No.B0190-16-2017, Resilient/Fault-Tolerant Autonomic Networking Based on Physicality, Relationship and Service Semantic of IoT Devices)

### 2. Discussion of Related Art

Recently, 70% or more of worldwide mobile traffic is video traffic, and video application users will increase further. Along with the increase in video traffic, video providers and clients require high-quality streaming technology, and much research is actively being conducted on higher video quality and seamless video play.

When a bottleneck link is shared, conventional data streaming methods and systems have problems in that one client uses most bandwidth resource of a corresponding link and the other users cannot be guaranteed an appropriate level of bandwidth usage.

### SUMMARY OF THE INVENTION

The present invention is directed to providing a client-side ACK regulation based adaptive streaming method and system that enable multiple clients to be guaranteed high average video rate at a bottleneck link.

The present invention is not limited to the above objective, but other objectives may be clearly understood by those skilled in the art from the following descriptions.

According to an aspect of the present invention, there is provided a client-side ACK regulation based adaptive streaming method including changing a goal download time (GDT) of a video segment to regulate an app buffer level; regulating reading of a receive socket on the basis of a leaky bucket by determining a size of a token using the changed GDT;, and controlling a size of a receive socket buffer on the basis of the determined number of tokens.

According to another aspect of the present invention, there is provided a client-side ACK regulation based adaptive streaming apparatus including a memory configured to store a program for providing a steaming processing module and a processor configured to execute the program. When the program is executed, the processor is configured to change a GDT of a video segment to regulate an app buffer level; regulate reading of a receive socket based on a leaky bucket by determining the number of tokens to generate at a time using the changed GDT; control a size of a receive socket buffer based on the determined number of tokens; probe an available bandwidth; determine a target throughput based on the probed available bandwidth and the app buffer level; and determine a video rate in a subsequent period using the target throughput.

### BRIEF DESCRIPTION OF THE DRAWINGS

The above and other objects, features and advantages of the present invention will become more apparent to those of ordinary skill in the art by describing example embodiments thereof in detail with reference to the accompanying drawings, in which:

FIG. 1 is an example diagram illustrating a configuration of a computer system in which a client-side ACK regulation based adaptive streaming method is implemented according to an embodiment of the present invention;

FIG. 2 is an example diagram illustrating a network configuration according to an embodiment of the present invention;

FIG. 3 is an example graph illustrating ON-OFF methods by comparing a related art with a client-side adaptive streaming (CLAS) according to an embodiment of the present invention;

FIG. 4A and FIG. 4B are graphs illustrating a download time and a throughput according to a size of a receive socket buffer according to an embodiment of the present invention;

FIG. 5 is a block diagram illustrating a streaming method by regulating a size of a receive socket buffer and using a leaky bucket according to an embodiment of the present invention;

FIG. 6 is a graph illustrating a method of probing an available bandwidth according to an embodiment of the present invention;

FIG. 7A, FIG. 7B and FIG. 7C are graphs illustrating a hybrid adaptive rate algorithm according to an embodiment of the present invention;

FIG. 8 is an example diagram showing a hybrid adaptive rate algorithm to describe a method of determining a target video rate of the next period using a target throughput value;

FIG. 9A is a graph showing a video rate time depending on a CLAS method, a buffer-based adaptation (BBA) method, and a FESTIVE method according to an embodiment of the present invention and FIG. 9B is a graph showing the amount of chunk download with time depending on a CLAS method, a buffer-based adaptation (BBA) method, and a FESTIVE method according to an embodiment of the present invention;

FIG. 10A and FIG. 10B are graphs obtained by measuring a degree of download at ACK intervals according to a CLAS method, a BBA method, and a FESTIVE method;

FIG. 11A, FIG. 11B, FIG. 11C, FIG. 11D and FIG. 11E are graphs showing a result of a quality test of streaming service according to a CLAS method, a BBA method, and a FESTIVE method;

FIG. 12A and FIG. 12B are graphs showing cumulative distribution of a round trip time (RTT) between a client and a server; and

FIG. 13 is a process flowchart illustrating a client-side ACK regulation based adaptive streaming method according to an embodiment of the present invention.

### DETAILED DESCRIPTION OF EXAMPLE EMBODIMENTS

Advantages and features of the present invention and implementation methods thereof will be clarified through following embodiments described with reference to the accompanying drawings. The present invention may, however, be embodied in different forms and is not to be construed as limited to the embodiments set forth herein. Rather, these embodiments are provided so that this disclosure is thorough and complete and fully conveys the scope of the present invention to those skilled in the art. The terminology used herein is for the purpose of describing particular embodiments only and is not intended to limit the invention. As used herein, the singular forms “a,” “an,” and “the” are intended to include the plural forms as well unless clearly indicating otherwise by context. It should be further understood that the terms “comprises” and/or “comprising” specify the presence of stated features, integers, steps, operations, elements, and/or components when used in this specification, but do not preclude the presence or addition of one or more other features, integers, steps, operations, elements, components, and/or groups thereof.

Hereinafter, example embodiments of the present invention will be described in detail with reference to the accompanying drawings.

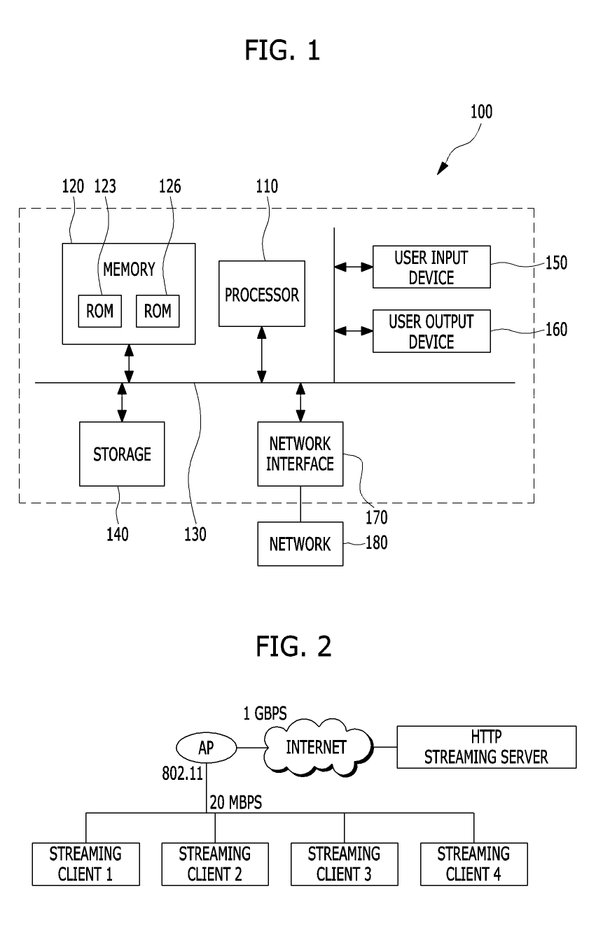

FIG. 1 is an example diagram illustrating a configuration of a computer system in which a client-side ACK regulation based adaptive streaming method is implemented according to an embodiment of the present invention.

Meanwhile, the client-side ACK regulation based adaptive streaming method according to an embodiment of the present invention may be implemented in a computer system or recorded in a recording medium. As shown in FIG. 1, a computer system may include at least one processor 110, a memory 120, a user input device 150, a data communication bus 130, a user output device 160, and a storage 140. The above-described elements perform data communication through the data communication bus 130.

The computer system may further include a network interface 170 that is coupled to a network 180. The processor 110 may be a central processing unit (CPU) or a semiconductor device that processes instructions stored in the memory 120 and/or the storage 140.

The memory 120 and the storage 140 may include various forms of volatile or non-volatile storage media. For example, the memory 120 may include a read-only memory (ROM) 123 and a random access memory (RAM) 126.

Accordingly, the client-side ACK regulation based adaptive streaming method according to an embodiment of the present invention may be implemented in a computer executable method. When the client-side ACK regulation based adaptive streaming method according to an embodiment of the present invention is performed by a computer device, computer-readable instructions may perform an operating method according to the present invention.

The client-side ACK regulation based adaptive streaming method according to an embodiment of the present invention may also be implemented as computer-readable codes on a computer-readable recording medium. The computer-readable recording medium includes any kind of recording media for storing data which can be thereafter read by a computer system. Examples of the computer-readable recording medium may include a ROM, a RAM, a magnetic tape, a magnetic disk, a flash memory, an optical data storage device, etc. The computer-readable recording medium can also be distributed over computer systems connected through a computer communication network so that the computer-readable codes are stored and executed in a distributed fashion.

A client-side ACK regulation based adaptive streaming apparatus according to an embodiment of the present invention includes a memory configured to store a program for providing a steaming processing module, and a processor configured to execute the program. When the program is executed, the processor is configured to change a goal download time (GDT) of a video segment to regulate an app buffer level, regulate reading of a receive socket based on a leaky bucket 532 by determining the number of tokens to generate at a time using the changed GDT, control a size of the receive socket buffer based on the determined number of tokens, probe an available bandwidth, determine a target throughput based on the probed available bandwidth and the app buffer level, and determine a video rate in a subsequent period using the target throughput.

FIG. 2 is an example diagram illustrating a network configuration according to an embodiment of the present invention.

An HTTP streaming server is located in a content delivery network (CDN), and multiple streaming clients are connected to one AP and share a wireless bottleneck link. Each client has a socket buffer and an application buffer, and determines a video rate according to conditions of the buffers and the network and sends a request to the HTTP streaming server. The HTTP streaming server responds to the request by sending a corresponding video segment to the client.

An adaptive video streaming method that is currently in service dynamically regulates video quality according to network conditions and network demands, and provides appropriate service quality. However, some studies indicate that an adaptive video streaming service may show poor performance in a wireless Internet environment when multiple streaming clients share a bottleneck link.

The present invention will provide client-side ACK regulation based adaptive streaming (CLAS), which is a novel video rate selection schema. Typically, video rate is closely related to quality of video to be provided through streaming service. Video rate is classified based on average data size of video sequences played in a second. Data size of video sequences may vary depending on a method of generating and compressing a video provided through a streaming service. Generally, for the same codec video, quality increases as video rate increases. A video with a high-level video rate is provided when the network conditions are good, and a video with a low-level video rate is provided when the network conditions are bad. An HTTP streaming server contains a plurality of video segments (or chunks) obtained by dividing video file data at certain time intervals (a chunk time T, e.g., T=4 sec) by different video rates, and provides a video segment with an appropriate video rate to a streaming client according to network conditions.

Streaming Quality of Experience (QoE) may be evaluated according to several kinds of criteria. For example, streaming QoE may be evaluated using a provided video rate, stability of a video rate, fairness among multiple clients, the number of rebuffering events, and a chunk download time, which is an average download time of video segments.

The CLAS method is intended to enhance streaming QoE using a method of estimating an available bandwidth (ABW) and selecting a video rate. Typically, streaming service uses an on-off transmission pattern in order to prevent one client from using too many resources from an AP, and thus has difficulties in measuring an ABW. This is because it is impossible to measure an ABW in a communication mode off period and it is inaccurate to use only a measurement result from an on peirod to estimate an ABW. The present invention is intended to maintain a certain level of transmission rate by removing an off periods and regulating a transmission rate at a client side.

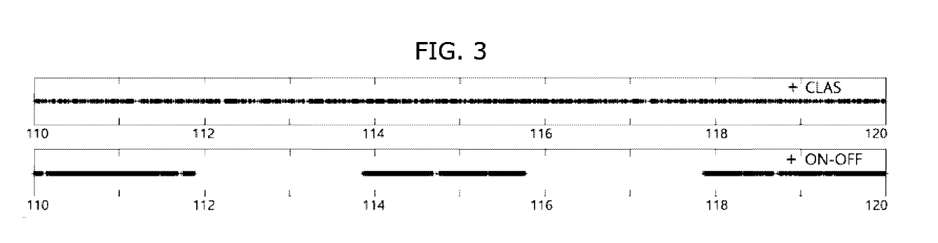

FIG. 3 is an example graph illustrating transmission patterns by comparing a conventional on-off method with the CLAS method of the present invention.

An upper graph indicates a transmission pattern according to the CLAS method of the present invention, and a lower graph indicates a transmission pattern according to a conventional on-off method. It can be seen that video data is downloaded over the entire time according to the CLAS method, and video data is intensively downloaded for a certain time (an on duration) and is not downloaded at all for a certain time (an off duration) according to the on-off method.

Recently, in developed countries, real-time entertainment traffic occupies 70% of the entire traffic at a peak time, and a percentage occupied by video streaming is expected to increase gradually according to adoption of wireless Internet and smart mobile devices. It is common to provide streaming service to multiple clients at the same time in the same wireless Internet environment. Instead of downloading the entire data for video service, video segments or chunks with small sizes are downloaded and played. Also, an adaptive streaming service, for example, a very remarkable Dynamic Adaptive Streaming over HTTP (DASH) service, enables an appropriate quality of video segments to be selected depending on a user's network conditions.

Service is provided at high video rates in a good network environment, and otherwise service is provided at low video rates.

Since QoE of a streaming service increases in proportion to the video rate, a streaming service system may estimate an ABW of a network and provide service at a maximum video rate which the network may maintain. Such technology is called adaptive bit rate selection (ABR). In recent years, many researchers have invented many novel devices in order to solve problems of ABR.

Some methods emphasize the role of a buffer and determine a transmission rate based on an app buffer level. Unlike service such as FTP, which continuously uses a network band, an adaptive streaming service intermittently uses a network band (in an on-off transmission pattern). However, researchers found poor performance, unfairness, and instability of the adaptive streaming service when the on-off transmission pattern was used.

The present invention improves inaccurate ABW estimation by regulating a data transmission rate to remove an on-off pattern or implement an on-off pattern in a very short time. A transmission control protocol (TCP) connection uses a congestion window and an advertised window (a receive window size transmitted from a receiver) to determine the transmission rate. This is called congestion control. Congestion control is performed according to a mechanism of slow start, congestion avoidance, fast transmission, and fast recovery.

An appropriate socket buffer size is used to regulate transmission rate of a server and a socket buffer read rate is controlled. The on-off pattern is removed by limiting transmission rate of data segments, and a video rate that is most suitable for a subsequent segment is determined by accurately estimating the ABW.

An effect of the present invention will be compared with FESTIVE and buffer-based adaptation (BBA), which are other known client-side streaming methods. The CLAS method selects the most suitable video rate on the basis of the estimated ABW and the app buffer level. According to an embodiment of the present invention, an average video rate increases by 20% and the rebuffering rate decreases significantly when compared to the FESTIVE and BBA.

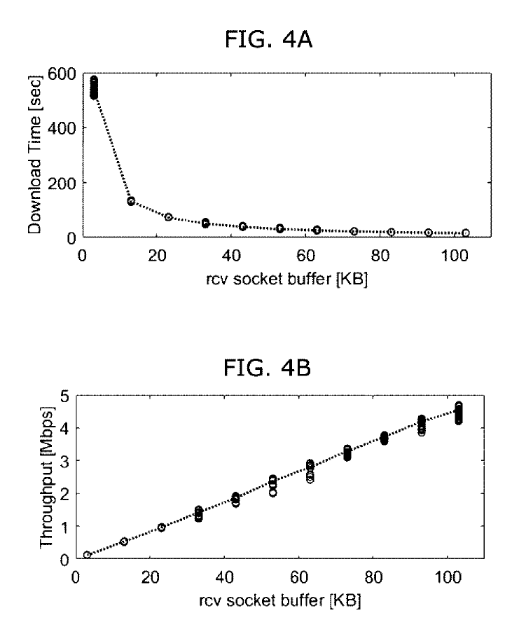

FIG. 4A and FIG. 4B are graphs illustrating a download time and a throughput according to a size of a receive socket buffer according to an embodiment of the present invention.

According to the present invention, the receive socket buffer is determined depending on a round trip time (RTT). For example, an RTT measured when a client connected to an AP in Seoul, South Korea connects to a server in Busan, South Korea is 13 ms, and an RTT measured when the client connects to a server located in Oregon, USA is 130 ms.

FIG. 4A shows that a download time decreases as the size of the receive socket buffer increases but decreases less as the size of the receive socket buffer exceeds a certain level (e.g., 40 KB). It can be seen that a throughput increases as the size of the receive socket buffer increases on FIG. 4B. However, the size of the receive socket buffer cannot be infinitely increased in a TCP. Accordingly, it is possible to decrease the download time and increase the throughput by appropriately regulating the size of the receive socket buffer.

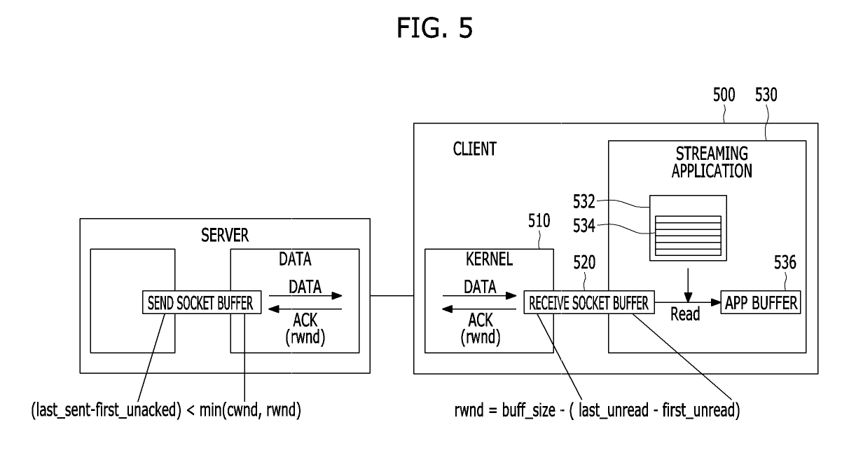

FIG. 5 is a block diagram illustrating a streaming method by regulating a size of a receive socket buffer 520 and using a leaky bucket 532 according to an embodiment of the present invention.

An existing adaptive streaming method has difficulty in accurately measuring an ABW under on-off restrictions. Thus, most ABR techniques focus on accurate estimation of an ABW under on-off restrictions. The present invention is intended to remove an on-off pattern by regulating a data transmission rate. In order to regulate traffic, conventional techniques mainly use a method of establishing a leaky bucket at a server side. Unlike this, the present invention establishes a leaky bucket at a client side.

The present invention is the first attempt to regulate data transmission to maintain packets arriving at a client side. Existing techniques establish a leaky bucket at a server side and thus should receive network conditions or the like from a client (500). Accordingly, such techniques have problems in that control is delayed and expandability is limited.

An adaptive streaming service such as DASH regulates a transmission rate by using a TCP ACK transmission method. Thus, such a service has a problem in that, when a TCP congestion window size, cwnd, is large, a server cannot be regulated because the server transmits many segments without receiving an ACK signal according to an embodiment of the present invention.

Since a TCP receive window size, rwnd, is controlled in the present invention, TCP flow control at a server side has MIN(cwnd, rwnd) as a limit. rwnd is obtained by the following equation:

rwnd=receive_socket_buff_size−(last_unread−first_unread). [Equation (1)]

The number of available segments (i.e., number of inflight segments) of a send socket buffer is determined by the following equation:

Number of inflight segments=min(cwnd, rwnd). [Equation (2)]

Since cwnd is a value determined at a server side and rwnd is a value determined at a client side, an available buffer of a send socket at the server side may be regulated by regulating a value of rwnd of a receive socket buffer 520 at the client side.

The value of rwnd is determined on the basis of a RTT between the server and the client. RTT refers to a time for a response to be received after a request is sent from a client. Typically, RTT tends to be determined by the number of routers connected between a server and a client.

Even when the value of rwnd is regulated in association with the size of the receive socket buffer 520 as described above, the on-off pattern may not be removed. As shown in FIG. 4A, because a download time may be sufficiently short even when the size of the receive buffer is small, the on-off pattern cannot be perfectly removed by only regulating the size of the receive buffer.

More precise control is required for removing the on-off pattern and smoothly and continuously transmitting packets. The present invention is intended to solve this problem by implementing a leaky bucket 532 at a client side.

A leaky bucket 532 is a structure for controlling a read function of a client-side receive socket. A read function of a TCP socket fills a predetermined app buffer 536 with data delivered from a server. The on-off pattern may be removed by filling the app buffer 536 with an amount of data equal to the number of tokens in the leaky bucket 532. The app buffer 536 may typically refer to a buffer of a video player and is much greater than a receive socket buffer 520. When a video player is operated through a streaming service, several tens of seconds of video clip may be stored in the app buffer 536. According to an embodiment of the present invention, a value obtained by changing the amount of video sequences stored in the app buffer 536 in time is represented as an app buffer level B(t).

A token 534 is generated according to a current video rate, and a client loads data corresponding to the number of tokens from the receive socket buffer 520 to an application buffer. Typically, for x bytes of tokens, x bytes of video data are loaded. This is called a buffer level control mechanism. The upper graph of FIG. 3 is obtained by using a CLAS method that regulates a buffer size of a receive socket and implements a leaky bucket structure using a token 534 between the receive socket and the application buffer. On the other hand, the lower graph of FIG. 3 is data obtained by general adaptive streaming method using an on-off pattern.

The client-side ACK regulation based adaptive streaming method according to an embodiment of the present invention includes changing a GDT of a video segment to regulate an app buffer level, regulating reading of a receive socket on the basis of a leaky bucket 532 by determining the number of tokens to generate at a time using the changed GDT, and controlling a size of the receive socket buffer 520 on the basis of the determined number of tokens.

The GDT is changed by the following equation:

GDT=f_{G}(B(t)=(1−g)*(T−minRTT) [Equation (3)]

wherein T denotes a video segment play time, and g satisfies 0<g<1 and approaches zero as the app buffer level B(t) increases and approaches 1 as the app buffer level B(t) decreases. For example, g may be expressed as a step function that satisfies g [symbol] 0, 0.75] according to B(t).

Typically, a chunk time T, which is a video segment play time, may be 4 sec. In this case, GDT should be less than 4 sec. When GDT exceeds 4 sec, a video download time exceeds a video play time, and thus a video cannot be smoothly played. One RTT may be consumed for each video segment, and thus T-minRTT is set as an upper limit of GDT where minRTT is the minimum value among measured RTTs. The RTT may be calculated on the basis of a time for a response to be received after an HTTP get request is sent to a CDN that provides a video streaming service. This has almost the same value as an actual RTT since the server's processing time is negligibly short. When the app buffer level is sufficient and minRTT is small, GDT is almost the same as T. That is, a video segment play time T is almost the same as a video segment download time (a chunk download time).

Since the app buffer level being low indicates that a small number of frames are pre-downloaded, the app buffer level may be increased by decreasing GDT (that is, by increasing g).

In the present invention, video data stored in the receive socket buffer 520 is loaded and stored in the app buffer 536 depending on the number of generated tokens. A generation period of a token 534 is based on the RTT. A size tk(Sᵢ) of a token 534 that is generated once is determined by the following equation:

$$tk ( {S}_{i} ) = \frac{FS ( {S}_{i} ) * RTT}{GDT} , \qquad [ Equation ( 4 ) ]$$

where Sᵢ denotes an i^{th} video segment, FS(Sᵢ) denotes a segment size of Sⁱ in byte, RTT stands for a round trip time and denotes the time it takes for a client's request to be sent and a server's response to be received, and GDT denotes the above-described GDT.

For example, when FS(Sᵢ) is 2,000,000 bytes, RTT is 13 ms, and GDT is 3.2 sec, the number of tokes to generate at a time tk(Sᵢ) is 8,125 bytes. While GDT=3.2 sec, transmissions are made about 246 times in a period of RTT (=13 ms). About 2,000,000 bytes are received while GDT=3.2 sec. However, GDT is merely a goal download time. Actually, not all of the 8,125 bytes may be received, and the number of transmissions during the GDT may be less than 246. Accordingly, an actual download time DT(Sᵢ) may exceed the GDT. However, since the receive socket read function is directly controlled by the number of tokens filled in the leaky bucket 532, the actual download time DT(Sᵢ) cannot be smaller than the GDT.

The receive socket buffer size is determined on the basis of the number of tokens tk(Sᵢ) by the following equation:

sk(Sᵢ)=(1+d)*tk(Sᵢ). [Equation (5)]

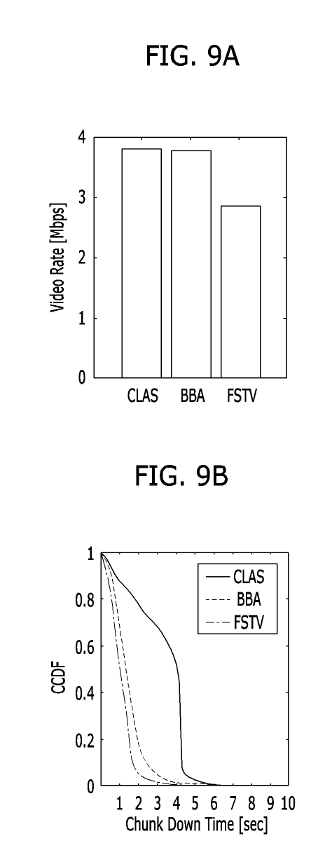

Assuming an ideal network, when data packets are continuously input, the receive socket buffer size sk(Sᵢ) may be equal to the number of tokens tk(Sᵢ). However, according to characteristics of TCP, packets are input in bursts over an actual network. Thus, the socket buffer size is set to be somewhat greater than the determined number of tokens to generate at a time. FIGS. 9 to 12 show results obtained when d=1, which do not limit the scope of the invention. For example, it was confirmed that a bursty result is not shown even when d=2 or d=3.

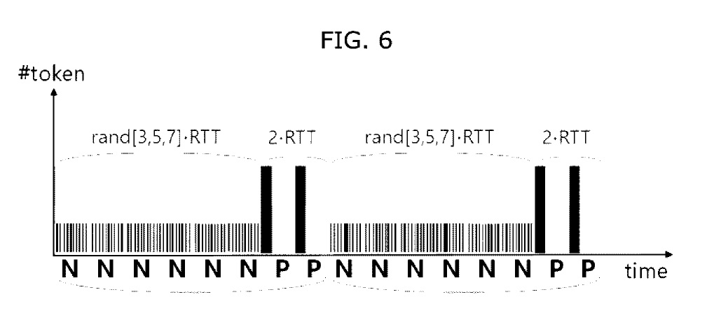

FIG. 6 is a graph illustrating a method of probing an ABW according to an embodiment of the present invention.

Typically, an ABW is used by estimating a throughput. For a streaming application 530, a throughput uses

$$\frac{FS ( {S}_{i} )}{DT ( {S}_{i} )} .$$

However, according to an embodiment of the present invention, the throughput is less than or equal to

$$\frac{FS ( {S}_{i} )}{GDT}$$

even when a network environment is good because DT(Sᵢ)>GDT. Accordingly, even when the ABW is greater than or equal to

$$\frac{FS ( {S}_{i} )}{GDT}$$

in an actual network environment, it is impossible to be aware of that fact. In other words, because of the rate regulation, the measured throughput cannot be used as the ABW. The present invention proposes a method of probing an ABW in order to accurately estimate the ABW.

The ABW probing method is divided into a general period N and a probing period P. The general period N uses the data streaming method described above, The probing period P includes a period of a small number of RTT units. In the probing interval P, the number of tokens to generate at a time is determined on the basis of higher video rate.

According to Equation (4) above, since FS(S₁₃ i) of a higher video rate is larger, the token size also increases, and thus more data is received. When a higher video rate is hV(Sᵢ), FS(S_i)=hV(Sᵢ)*(chunk size). Accordingly, the size of the generated token tk(Sᵢ) and the receive socket buffer size skp(Sᵢ) are obtained by the following equation:

$$\begin{matrix}tkp ( {S}_{i} ) = \frac{hV ( {S}_{i} ) * ( chunk size ) * RTT}{GDT} & [ Equation ( 6 ) ] \\ skp ( {S}_{i} ) = ( 1 + d ) * tkp ( {S}_{i} ) . & [ Equation ( 7 ) ]\end{matrix}$$

Throughputs measured in the general period and a probing period may be used as average values for those corresponding periods and may also be calculated as exponentially weighted moving average (EWMA) values. A value that is not the smaller value between the two throughputs measured in the general period and the probing period is determined as a target throughput. The target throughput may be considered as an estimated ABW. However, the target throughput may be determined in consideration of the app buffer level as well as the estimated ABW. The method is called a hybrid rate selection method in that both of the estimated ABW and the app buffer level are considered.

In the graph of FIG. 6, it is assumed that the probing period is maintained during 2*RTT and the general period is maintained during Rand(3,5,7)*RTT where the function Rand( ) is the random function selecting one value arbitrarily among the multiple inputs, so that when there are multiple clients, probing period of the clients do not overlap. However, in order to prevent multiple clients from being in the probing period at the same time, the length of the probing period and that of the general period should be appropriately regulated, but this does not limit the scope of the invention. For example, the probing period may be set as 3*RTT, and the general period may be set as Rand(5,7,11)*RTT.

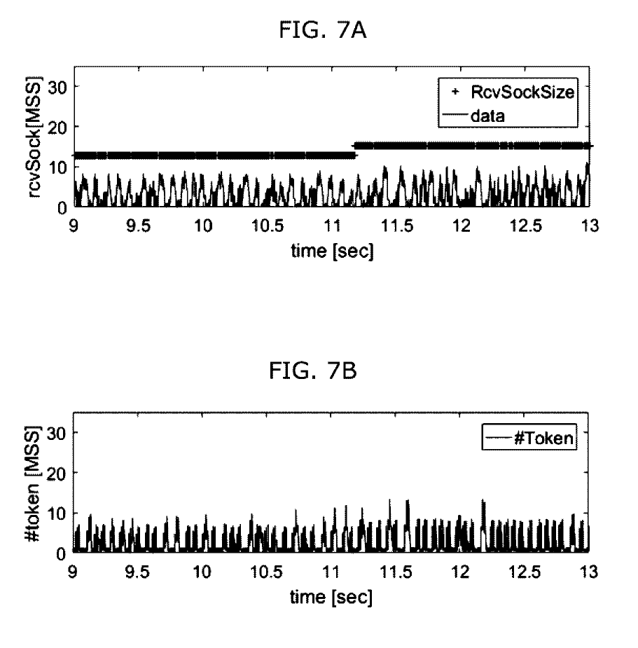

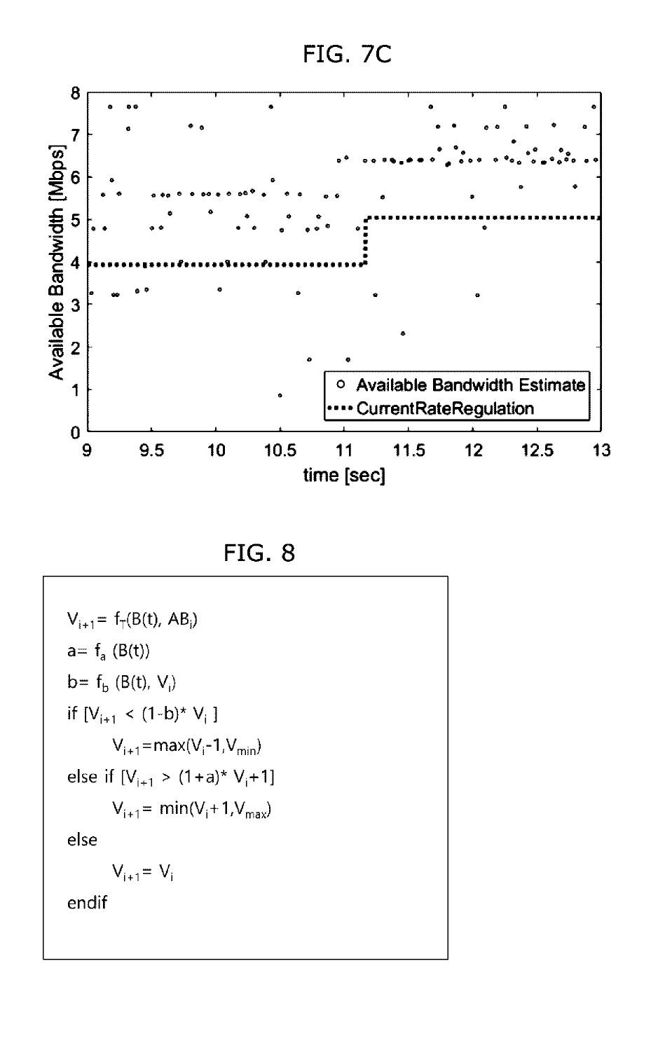

FIG. 7A, FIG. 7B and FIG. 7C are graphs illustrating a hybrid adaptive rate algorithm according to an embodiment of the present invention.

FIG. 7A indicates a receive socket buffer size and a received data amount that change over time. FIG. 7B indicates the number of tokens in a leaky bucket 532 over time, and FIG. 7C indicates a measured value of an ABW over time. FIG. 7A, FIG. 7B and FIG. 7C show results obtained by increasing a target video rate from 4 Mbps to 5 Mbps at a point of 11.2 sec. Better quality of video steaming service may be received by probing good network conditions near 11.2 sec in the probing period and increasing the target video rate.

The target video rate for the next segment is changed by using the throughput determined in the description of FIG. 6. When the video rate is changed, a file size of a video segment is also changed. This affects an app buffer level and thus also affects a GDT, the number of tokens to generate at a time, and a receive socket buffer size. Accordingly, the QoE of the streaming service is affected by all these changes as shown in FIG. 7A, FIG. 7B and FIG. 7C.

FIG. 8 shows a hybrid rate adaptation algorithm for describing a method of determining a target video rate for the next segment using a target throughput value.

An i^{th} segment (chunk) and a video rate of the i^{th} segment are denoted as Sᵢ and Vᵢ, respectively. A one-level higher video rate is denoted as Vᵢ+1, and a one-level lower video rate is denoted as Vᵢ−1.

In pseudo code of FIG. 8, ABᵢ indicates a target throughput calculated in FIG. 6. fT(B(t), ABᵢ) indicates a hybrid target throughput. An EWMA target throughput of the i^{th} segment may be used. A value that is not the smaller of the throughput of the probing period and the throughput of the general period is adopted as an estimated ABW, ABᵢ, and the hybrid target throughput is calculated in consideration of both ABᵢ and the app buffer level. fT(B(t), ABᵢ) may simply use the following equation:

fₜ(B(t), ABᵢ)=(1−r)*ABᵢ. [Equation (8)]

where r decreases as B(t) increases, and increases as B(t) decreases, and 0<r<1 is satisfied.

0<r<0.4 was used in the experiment, but this does not limit the scope of the invention.

Since the determined video rate tends to increase as the app buffer level B(t) increases, r is set to be lower as B(t) increases, and set to be higher as B(t) decreases. Accordingly, when the target throughput decreases, the target video rate decreases and the app buffer 536 is filled quickly to increase the app buffer level and avoid rebuffering.

In FIG. 8, as the app buffer level B(t) increases, a decreases and b increases.

The first “if” statement decreases the video rate. When the app buffer level B(t) is high, both of the target throughput Vᵢ₊₁ and b are large, and thus the probability of not being included in the first “if” statement increases. When the app buffer level B(t) is low, both of the target throughput Vᵢ₊₁ and b are small, and thus the probability of being included in the first “if” statement to decrease a target video rate in an i+1^{th} video segment increases. However, a presented Vₘᵢₙ is used as a lower limit. Vₘᵢₙ and Vₘₐₓ indicates minimum and maximum video rate, respectively.

The second “else if” statement increases the video rate. When the buffer level B(t) is high, the target throughput Vᵢ₊₁ is large and b is small, and thus the target video rate in the i+1^{th} video segment increases. However, when the buffer level B(t) is small, the second “else if” statement is not applied.

When the video rate is not increased or decreased, the video rate is maintained and processed by the last “else” statement.

FIG. 9A is a graph showing average video rate depending on a CLAS method, a BBA method, and a FESTIVE method according to an embodiment of the present invention. FIG. 9B is a graph showing cumulative distribution of an actual chunk download time depending on a CLAS method, a BBA method, and a FESTIVE method according to an embodiment of the present invention.

FIG. 9B, it can be seen that when the CLAS method according to an embodiment of the present invention is used, a point near t=4 has the highest distribution of the actual chunk download time. Since the CLAS method according to an embodiment of the present invention regulates GDT close to a video chunk play time (the chunk time T; e.g., T=4), the actual chunk download time will have the highest density near T when the CLAS method is used. Meanwhile, since the BBA method and the FESTIVE method maintain an on-off pattern and perform download, the actual chunk download time is smaller than T. The BBA method and the FESTIVE method have low bandwidth utilization due to an off period. The CLAS method eliminates off period and uses a bandwidth in a temporally distributed fashion. Thus, a high average video rate may be maintained even when multiple clients in a bottleneck link receive a video streaming service from the same AP.

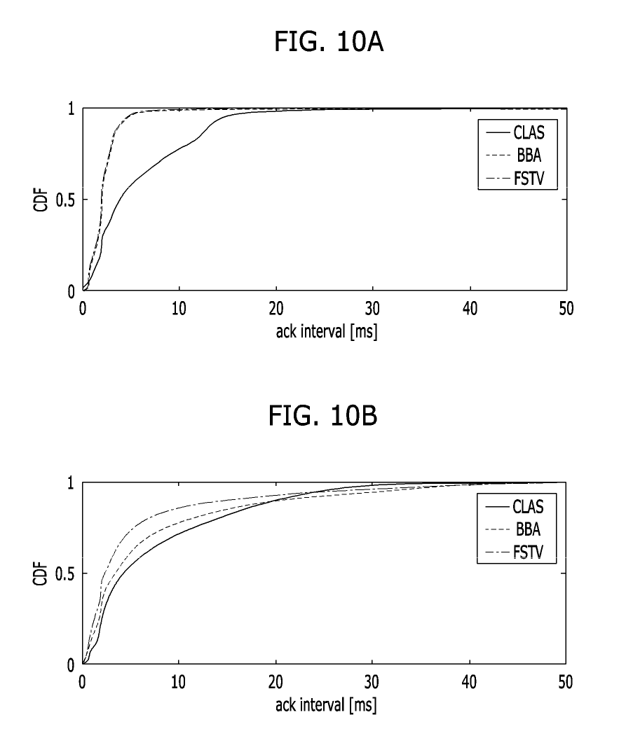

FIG. 10A and FIG. 10B are graphs showing cumulative distribution of ACK intervals according to a CLAS method, a BBA method, and a FESTIVE method. FIG. 10A shows a result measured by one client when one client connected to one AP receives a streaming service, and FIG. 10B shows a result measured by one client when four clients connected to one AP receive a streaming service. It can be seen that the BBA method and the FESTIVE method tend to have bursty traffic pattern because the methods depend on TCP characteristics. On the other hand, it can be seen that the CLAS method has a more distributed traffic pattern over time because the CLAS method controls socket read function.

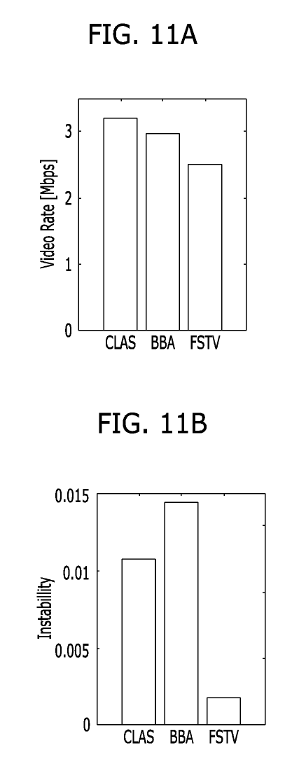

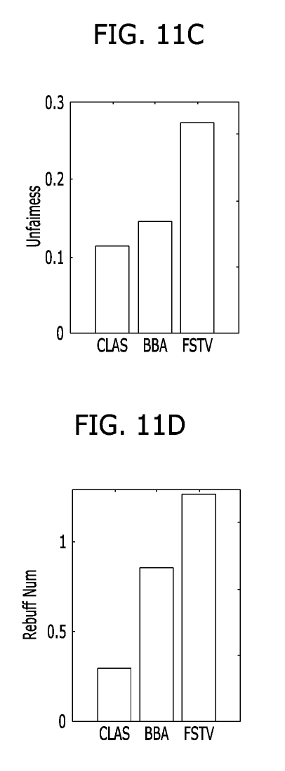

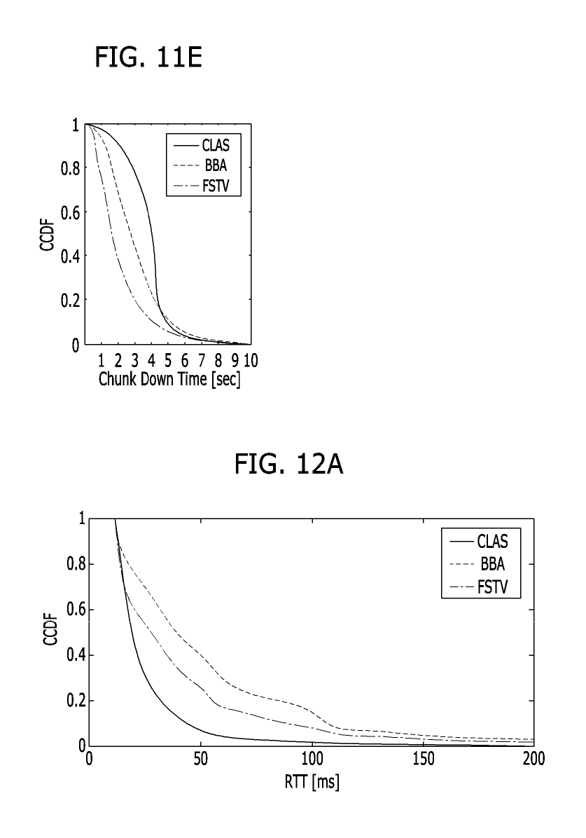

FIG. 11A, FIG. 11B, FIG. 11C, FIG. 11D and FIG. 11E are graphs showing a result of a quality test of a streaming service according to a CLAS method, a BBA method, and a FESTIVE method.

The quality of the streaming service is evaluated using a video rate, stability, fairness, a rebuffering number, and a chunk download time, which is an average download time of video segments.

FIG. 11A shows that the CLAS method has the best video rate and the FESTIVE method has the worst video rate.

Instability increases in proportion to the number of times a video rate is changed in a certain time (e.g., 20 sec) and the gap between the two consecutive video rates. When a video rate is frequently changed while actual video is played, a viewer feels discomfort. FIG. 11B shows that the FESTIVE method has the best stability and the BBA method has the worst stability. The stability may be measured in various ways. For example, the number of times a video rate is changed in 20 seconds may be counted, and this counting is repeated in units of one second to calculate stability for the entire video streaming service.

Unfairness refers to a standard deviation of an average video rate of multiple clients being large. FIG. 11C shows that the CLAS method has the best fairness and the FESTIVE method has the worst fairness.

Rebuffering refers to storing video data to be played in the near future in an app buffer 536 while video play is temporality stopped for the purpose of smooth video play. As rebuffering increases, QoE decreases. FIG. 11D shows that the CLAS method has the best rebuffering number and the FESTIVE method has the worst rebuffering number.

FIG. 11E shows cumulative distribution of a chunk download time, which is an average download time of video segments. It can be seen that the BBA method and the FESTIVE method tend to have short chunk download time showing the highest density at a lower side compared to the chunk time T because the BBA method and the FESTIVE method have a bursty trend and cannot remove an off period. On the other hand, it can be seen that the CLAS method removes an off period using the reading control method and performs download in a distributed fashion over the entire streaming session.

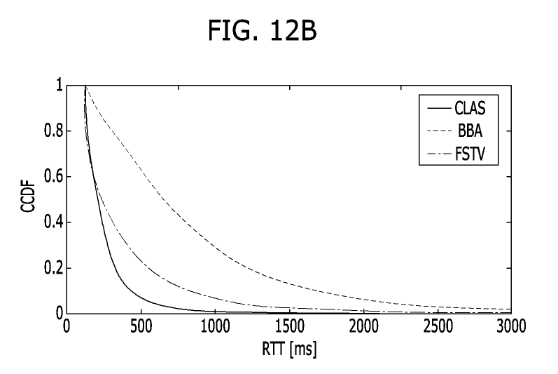

FIG. 12A and FIG. 12B show cumulative distribution of a RTT between a client and a server.

FIG. 12A shows cumulative distribution between a client and a server located in Busan, South Korea, and FIG. 12B shows cumulative distribution between the client and a server located in Oregon, USA.

Since the BBA method and the FESTIVE method proceed with a download in a bursty way, an RTT time further increases when multiple clients receive video streaming service through bottleneck connection. It can be seen from FIG. 12A and FIG. 12B that the BBA method and the FESTIVE method have larger average RTT values than the CLAS method. Also, it can be seen that FIG. 12B has a similar pattern to FIG. 12A, except that the RTT value increases by a factor of 10 due to connection to a server located in Oregon, USA.

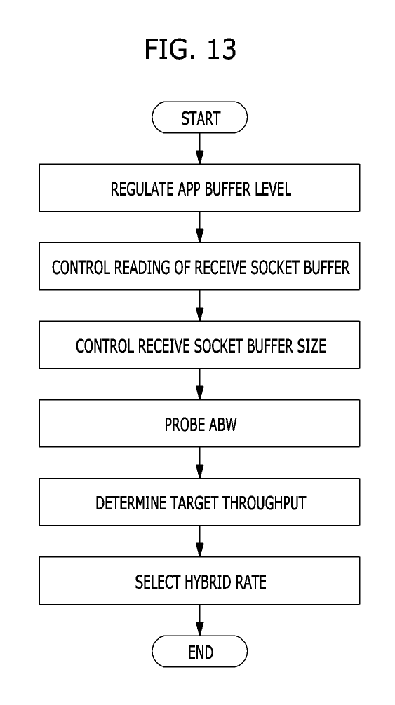

FIG. 13 shows a process flowchart illustrating a client-side ACK regulation based adaptive streaming method according to an embodiment of the present invention.

The client-side ACK regulation based adaptive streaming apparatus according to an embodiment of the present invention includes changing a GDT of a video segment and regulating an app buffer level, regulating reading of a receive socket based on a leaky bucket 532 by determining the number of tokens to generate at a time using the changed GDT, controlling a size of a receive socket buffer based on the determined number of tokens, probing an available bandwidth, determining a target throughput based on the probed available bandwidth and the app buffer level, and determining a video rate in a subsequent period using the target throughput.

The present invention has good performance in terms of average video quality, stability, fairness, a rebuffering number, and traffic distribution relaxation and also mitigates buffer overflow (bloat) problem. The present invention is also provided at client-side application level, and thus can be easily employed. Also, the present invention could be helpful to solve problems with buffer bloat and greedy and bursty bandwidth usage when a large amount of data traffic is generated from, e.g., a data center or a CDN.

While the configuration of the present invention has been particularly shown and described with reference to the appending drawings and preferred embodiments, those of ordinary skill in the art should understand that various changes in form and details may be made therein without departing from the spirit and scope of the present invention. Accordingly, the technical scope of the present invention should not be limited to the above-described embodiments, but be determined only by the technical concept of the appended claims.

What is claimed is:

1. A client-side ACK regulation based adaptive streaming method, the client-side ACK regulation based adaptive streaming method comprising:
changing a goal download time (GDT) of a video segment to regulate an app buffer level;
regulating reading of a receive socket on the basis of a leaky bucket by determining the number of tokens to generate at a time using the changed GDT; and
controlling a size of a receive socket buffer based on the determined number of tokens.

2. The client-side ACK regulation based adaptive streaming method of claim 1, further comprising:
probing an available bandwidth;
determining a target throughput based on the probed available bandwidth and the app buffer level; and
determining a video rate of a subsequent video segment using the determined target throughput.

3. The client-side ACK regulation based adaptive streaming method of claim 1, wherein the GDT has a video segment play time as an upper limit, increases when the buffer level is sufficient, and decreases when the buffer level is deficient.

4. The client-side ACK regulation based adaptive streaming method of claim 1, wherein the regulating of reading of a receive socket comprises:
generating a token at intervals of a round trip time (RTT), the token having a size proportional to a size of the video segment and the RTT and inversely proportional to the GDT; and
storing the generated token in the leaky bucket and removing the generated token when data equal to the number of tokens is read from the receive socket buffer and the data is stored in an app buffer.

5. The client-side ACK regulation based adaptive streaming method of claim 2, wherein the probing of an available bandwidth comprises:
probing a general period including one or more RTT unit times and a probing period including the one or more RTT unit times;
calculating an available bandwidth for each of the general period and the probing period; and
generating, in the probing period, more tokens compared to that in the general period in proportion to the ratio of one level higher video rate to the current video rate.

6. The client-side ACK regulation based adaptive streaming method of claim 5, wherein the determining of a target throughput comprises:
comparing the available bandwidth calculated in the general period and the available bandwidth calculated in the probing period and using a value that is not a smaller value of the two available bandwidths as an available bandwidth estimated for the subsequent video segment; and
calculating the target throughput using the estimated available bandwidth and the app buffer level.

7. The client-side ACK regulation based adaptive streaming method of claim 6, wherein the determining of a video rate of a subsequent video segment comprises:
decreasing the video rate of the subsequent video segment as the app buffer level decreases, and increasing the video rate of the subsequent video segment as the app buffer level increases; and
increasing the video rate of the subsequent video segment as the estimated available bandwidth increases, and decreasing the video rate of the subsequent video segment as the estimated available bandwidth decreases.
